(19) United States
(12) Patent Application Publication
(10) Pub. No.: US 2016/0001594 A1
(43) Pub. Date: Jan. 7, 2016

(54) Afford-A-Aeros

(71) Applicants: Dean Gregory Golub, Chicago, IL (US); Jintana Nimla-Or, Chicago, IL (US)

(72) Inventors: Dean Gregory Golub, Chicago, IL (US); Jintana Nimla-Or, Chicago, IL (US)

(21) Appl. No.: 14/323,730

(22) Filed: Jul. 3, 2014

(51) Int. Cl. B60B 7/12; B60B 7/06; F16B 2/08; B60B 7/02

(52) U.S. Cl. CPC B60B 7/12; B60B 7/02; B60B 7/066; F16B 2/08; B60Y 2200/148; B60B 2900/111; B60B 2900/1216; B60B 2900/50

(57) ABSTRACT

Aerodynamic wheel cover systems may include a wheel hub attachment assembly coupled with a hub of a large vehicle, such as a truck. A wheel hub attachment assembly may be coupled to a wheel cover attachment device, and a lightweight aerodynamic wheel cover may be attached to the wheel hub attachment assembly via the wheel cover attachment device such that removal and installation of the aerodynamic wheel cover may be accomplished simply and expeditiously without tools.

### RELATED APPLICATIONS

Not Applicable

### BACKGROUND

The technical field to which this invention relates are methods of constructing and affixing aerodynamic wheel covers to the wheels of land vehicles, especially heavy trucks, whereby the wheel covers have improved maintenance, operation, functionality, cost-effectiveness, appearance, aerodynamics and fuel efficiency.

Wheel covers are common on cars, in part because the wheel rims provide a reliable mechanism for attachment and in part because car owners generally do not need to frequently access the lug nuts or other components covered by a hub cap.

In contrast, wheel covers for large vehicles such as semis are rarely used. Neither dual-wheels nor single-wide wheels are configured so that a wheel cover can be snapped into engagement as in the case with many passenger car wheel/wheel disk arrangements. Instead, dual wheels and single-wide wheels, especially on tractor-trailer vehicles and other large vehicles, are characterized by the substantial depth from the plane of the outer wheel rim inward to the region of the wheel hub where the wheel is attached to a brake drum, axle rotor, additional wheel or the like. This characteristic makes it difficult to secure a wheel cover to a dual wheel or single-wide wheel. Furthermore, a driver, mechanic or operator may need to inspect or access a hub odometer, an oil reservoir gauge, lug nuts, tire inflation valve, or some other component.

Tractor-trailers travel significant distances every year. Consequently, the cumulative effect of even incremental amounts of drag on a tractor-trailer can lead to significant increases in overall operating costs. Such increased transportation costs are typically absorbed by consumers of the products transported. One significant source of drag on tractor-trailers, and hence increased transportation costs, are the wheel assemblies of the tractor-trailers. In general, the aerodynamic drag of a vehicle increases when air flow is affected by a wheel opening, especially a deep wheel opening commonly found on tractor-trailer vehicles. Consequently, there is a need for wheel covers that decrease drag. However, as discussed previously, previous solutions for attaching covers to hubs are unsatisfactory for use with tractor trailers. Accordingly, embodiments described herein provide mechanisms and methods for attaching cover assemblies to wheel assemblies (as used herein, the term “wheel assembly” may refer to a single wheel or a dual wheel assembly, particularly as it relates to a tractor-trailer vehicle).

Some prior art methods of attaching a wheel cover to a truck wheel include a hub feature, such as a mounting bracket, that projects outwardly from the end of the wheel hub approximately to the plane of the wheel rim. These mounting brackets are constructed from rigid metal and attachment hardware such as screws and nuts. These attachment methods require tools and significant labor for installation or removal, which is necessary to perform most repairs or maintenance on the wheels.

Some prior art systems include a peripheral mounting method in which clips or other means attach a wheel cover to the outer flange of the wheel rim. However, attachment brackets which rely on hooks or spring clips are susceptible to loosening under stress and are difficult to install.

Some prior art systems and devices include rigid wheel covers. A disk, manufactured from aluminum or some other metal, is secured to a bracket using screws, bolts, or other hardware. A drawback to this type of wheel cover is the rigid disk is easily damaged by contact with a curb, post, or other traffic device. The time required for installation and removal of the cover, and the likelihood of a rigid cover rattling, making noise, and coming loose are also disadvantages. Some prior art methods involve installing a frame and then attaching (such as by using a zipper) a fabric shield to the frame. In operation, prior art approaches using a zipper typically utilize the inner bead or “drop-center” of the wheel. As such, prior art wheel covers may touch the outer flange but effectively “grabs” inside. A drawback is that this type of wheel cover does not fit all types of wheels, such as single-wide wheels, and requires the wheels to be cleaned when they may be heavily soiled and difficult to clean.

Furthermore, prior art methods of mounting wheel covers to the periphery of the wheel have shortcomings due to the difficulty of rigidly attaching a clip or other mounting feature to the outer wheel rim or flange. Further, the depth from the plane of the outer wheel rim inward to the region of the wheel hub where the inner diameter of the wheel is larger than elsewhere is typically several inches on dual wheels and single-wide wheels. As a result, these wheels cannot accommodate a wheel cover that can normally be snapped into engagement with the wheel outer flange (as in the case with many passenger car wheel/wheel disk arrangements, where conventional hub caps are used).

Furthermore, many of the prior art attachment systems are undesirably complex, either in the number of components required and/or the labor needed for installation and removal. The manufacturing costs of systems having a large number of components can be prohibitive.

Furthermore, many of the prior art wheel cover systems are comprised of many metal parts which are by virtue of being metallic, heavy. These metal parts pose a threat to the motoring public when these prior art systems dislodge due to the rigors of over the road travel. These metal parts can puncture tires or do damage to property or pose an injury risk when they come off the wheels at highway speed.

Furthermore, many of the prior art wheel covers are constructed of a solid surface with no openings to allow for ventilation that may assist to cool the hub area and adjacent brake components or to provide an exit means for water and debris.

Furthermore, most of the prior art wheel cover systems are expensive.

### PATENT CITATIONS

U.S. Pat. No. 2,614,001, U.S. Pat. No. 3,317,247, U.S. Pat. No. 4,241,954, U.S. Pat. No. 5,167,440, U.S. Pat. No. 5,135,289, U.S. Pat. No. 2,903,300, U.S. Pat. No. 8,382,210

### US Classifications

301/37.29, 301/37.32, 301/37.36, 301/37.102

### International Classifications

B60B7/04, B60B7/06, B60B7/12, B60B7/18

### SUMMARY

One aspect of embodiments described herein is to provide a means for attaching an aerodynamic wheel cover to a dual wheel or single-wide wheel assembly on a large vehicle.

Another aspect of embodiments described herein is to provide wheel cover mounting arrangements that are extremely lightweight.

Another aspect of embodiments described herein is to provide wheel cover mounting arrangements that are non-rigid.

Another aspect of embodiments described herein is to provide wheel cover mounting arrangements that allow for a range of geometric shapes of the wheel cover disk.

Another aspect of embodiments described herein is to provide aerodynamic wheel cover systems that are inexpensive to fabricate.

Another aspect of embodiments described herein is to provide aerodynamic wheel cover systems that are inexpensive to the consumer.

Another aspect of embodiments described herein is to provide wheel cover mounting arrangements such that a wheel cover can be installed and removed without tools and with minimal time and effort such that an individual removing and installing the wheel covers is not significantly inconvenienced by the wheel cover.

Another aspect of embodiments described herein is to provide aerodynamic wheel covers that are extremely lightweight.

The mechanism and associated wheel cover mounting method disclosed herein improve the wheel cover installation and removal process since the method requires no tools and can be accomplished faster and simpler, with fewer parts than existing wheel cover mounting methods and mechanisms.

An advantage to embodiments disclosed herein may be that a wheel cover is less susceptible to torsion or awkward loading like center-mounted disks, and that the wheel cover does not require an “inset” bead such as found in passenger cars/trucks.

An advantage may be the ability to provide advertising or other information for display to passers-by or an operator or maintenance personnel.

In one broad respect, embodiments disclosed herein may include a clamping assembly configured to couple to a wheel hub which can be simultaneously attached to a lightweight aerodynamic wheel cover via a wheel cover attachment device.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 depicts one embodiment of a wheel hub attachment assembly;

FIG. 2 depicts a side view of one embodiment of a wheel hub attachment assembly;

FIG. 3 depicts an end view of one embodiment of a circumference cable of a wheel hub attachment assembly in the clamped position around a typical wheel hub;

FIG. 4A depicts a side view of one embodiment of clamping cams in their unclamped positions while attached to a circumference cable;

FIG. 4B depicts a side view of one embodiment of clamping cams in their clamped positions while attached to a circumference cable;

FIG. 4C depicts a side view of one embodiment of clamping cams in their clamped positions while attached to a circumference cable while frontal pulling force is being applied to a circumference cable;

FIG. 5A depicts a side view of one embodiment of a wheel cover attachment device for mounting an aerodynamic wheel cover;

FIG. 5B depicts a convexly facing view of one embodiment of a wheel cover attachment device for mounting an aerodynamic wheel cover;

FIG. 6A depicts a front view of one embodiment of a lightweight aerodynamic wheel cover;

FIG. 6B depicts a side view of one embodiment of a lightweight aerodynamic wheel cover;

FIG. 7 depicts a side view of one embodiment of a lightweight aerodynamic wheel cover as it is attached to a typical wheel hub by one embodiment of a wheel cover attachment device and one embodiment of a wheel hub attachment assembly;

### DETAILED DESCRIPTION

Embodiments of the invention and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited to only those elements but may include other elements not expressly listed or inherent to such process, product, article, or apparatus. Further, unless expressly stated to the contrary, “or” refers to an inclusive “or” and not to an exclusive “or”. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead these examples or illustrations are to be regarded as being described with respect to one particular embodiment and as illustrative only. Those of ordinary skill in the art will appreciate that any term or terms with which these examples or illustrations are utilized encompass other embodiments as well as implementations and adaptations thereof which may or may not be given therewith or elsewhere in the specification and all such embodiments are intended to be included within the scope of that term or terms. Language designating such non-limiting examples and illustrations includes, but is not limited to: “for example,” “for instance,” “e.g.,” “in one embodiment,” and the like. Furthermore, any dimensions, materials or other such characteristics are provided by way of example and not limitation.

According to one embodiment, a wheel cover assembly may include a removable wheel cover or disk assembly coupled with a fixed hub mounting assembly that is mounted or otherwise coupled to a wheel assembly. The wheel assembly may be a single wheel or a dual wheel assembly, particularly as it relates to a tractor-trailer vehicle, or other type of wheel assembly.

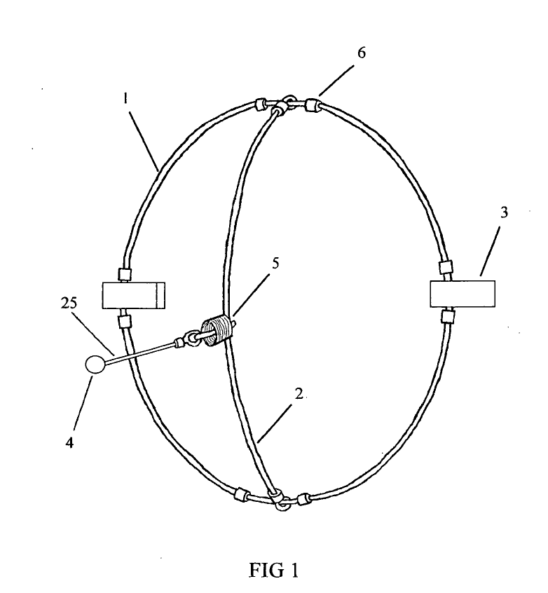

FIG. 1 depicts one embodiment of a wheel hub attachment assembly comprising a fixed length circumference cable 1, a fixed length crossover cable 2, eccentrically shaped clamping cams 3, a disk attachment cable 25, an attaching ball 4, a tension spring 5, various clamps and stop sleeves 6. Any part of this wheel hub attachment assembly can be constructed from different materials and use different mechanisms. For example; the circumference cable can be a non-stretch circumference rope or the attachment ball can be an attachment hook, etc. This embodiment of a wheel hub attachment assembly is manufactured by cutting thin steel cable into lengths, attaching stop sleeves, clamping cams, small ball, and cable clamps onto these lengths of cable. Then creating loops in these lengths of cable and fixing these loops permanently by pressing the cable clamps closed. Finally the stop sleeves and ball are fixed into permanent positions by pressing them closed onto the cable lengths.

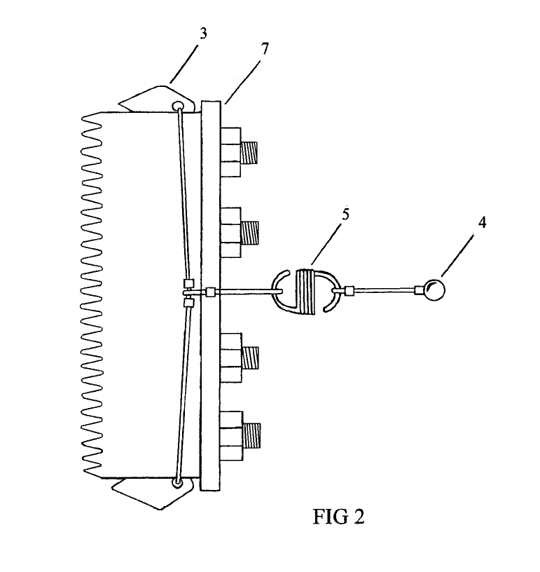

FIG. 2 depicts a side view of one embodiment of a wheel hub attachment assembly comprising clamping cams 3, a tension spring 5, an attaching ball 4, a typical wheel hub 7. The tension spring applies the force that simultaneously centers itself on the crossover cable and holds a lightweight aerodynamic wheel cover in place.

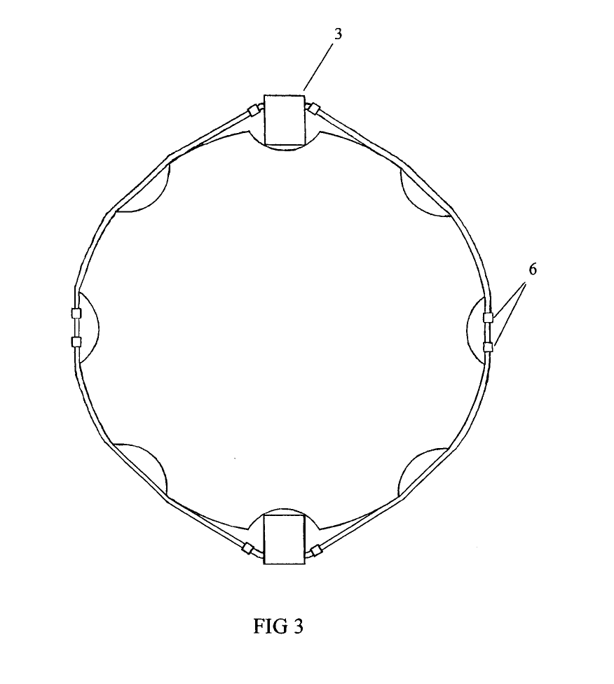

FIG. 3 depicts an end view of one embodiment of a circumference cable of a wheel hub attachment assembly in the clamped position around a typical wheel hub. The locking cams 3 clamp onto the wheel hub from opposing sides. The clamping action uses the fixed length nature of the circumference cable as a fulcrum for the eccentrically shaped locking cams. The circumference cable has stop sleeves to hold the locking cams on opposing sides and the crossover cable ends on opposing sides 6.

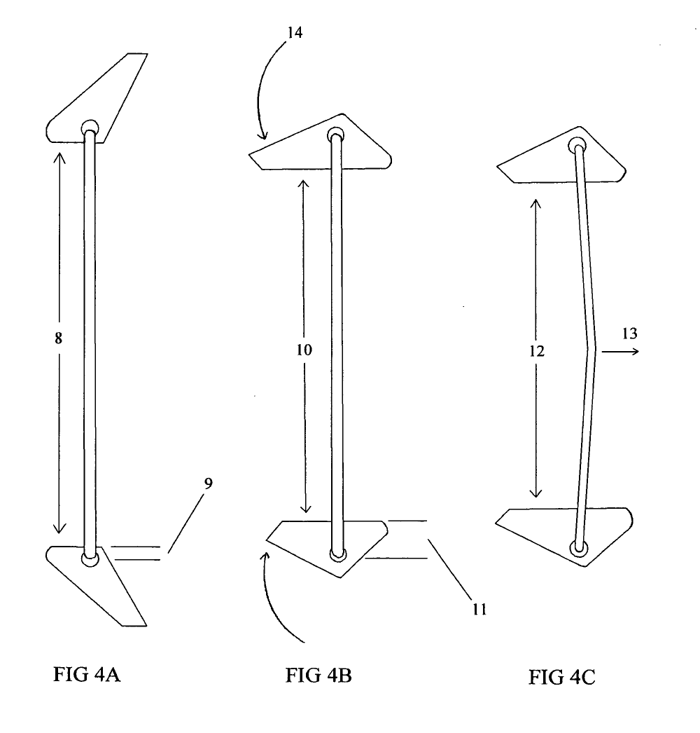

FIG. 4A depicts a side view of one embodiment of clamping cams in their unclamped positions while attached to a circumference cable. The measurement between the clamping cams is at its maximum in the unclamped position 8. This allows the circumference cable to fit over the end of the wheel hub. Correspondingly, the distance between the cable holes and the cam faces is at its minimum 9.

FIG. 4B depicts a side view of one embodiment of clamping cams in their clamped positions while attached to a circumference cable. The measurement between the clamping cams is nearly at its minimum in the clamped position 10. The cams are rolled into clamped positions as 14 illustrates. This action allows the cam faces to tighten onto the wheel hub. Correspondingly, the distance between the cable holes and the cam faces is at its maximum 11.

FIG. 4C depicts a side view of one embodiment of clamping cams in their clamped positions while attached to a circumference cable while frontal pulling force is being applied to the circumference cable. The measurement between the clamping cams is at its minimum in the clamped position 12 while frontal force is applied 13. The wheel hub attachment assembly's spring 5 is the mechanism for the aforementioned frontal force.

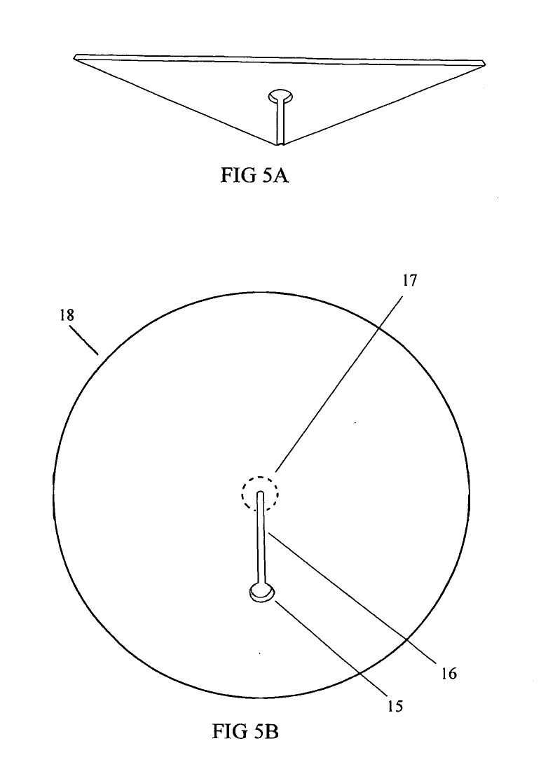

FIG. 5A depicts a side view of one embodiment of a wheel cover attachment device for mounting an aerodynamic wheel cover. This embodiment of a wheel cover attachment device is cone shaped and molded with rigid plastic.

FIG. 5B depicts a convexly facing view of one embodiment of a wheel cover attachment device for mounting an aerodynamic wheel cover from FIG. 5A. Approximately halfway between the base 18 and apex 17 of the wheel cover attachment device is a hole large enough for the attaching ball 4 on the wheel hub attachment assembly in FIG. 1 to fit through 15. The tension applied by the spring 5 on the wheel hub attachment assembly draws the ball to the apex of the wheel cover attachment device via a slot 16. The ball cannot fit through the apex of the wheel cover attachment device. The apex of the wheel cover attachment device is the closest part of the wheel cover attachment device to the wheel hub. Other embodiments of this wheel cover attachment device may be differently shaped and fabricated from different materials. For example; this wheel cover attachment device can be nothing more than a V shaped piece of wire that is hooked to.

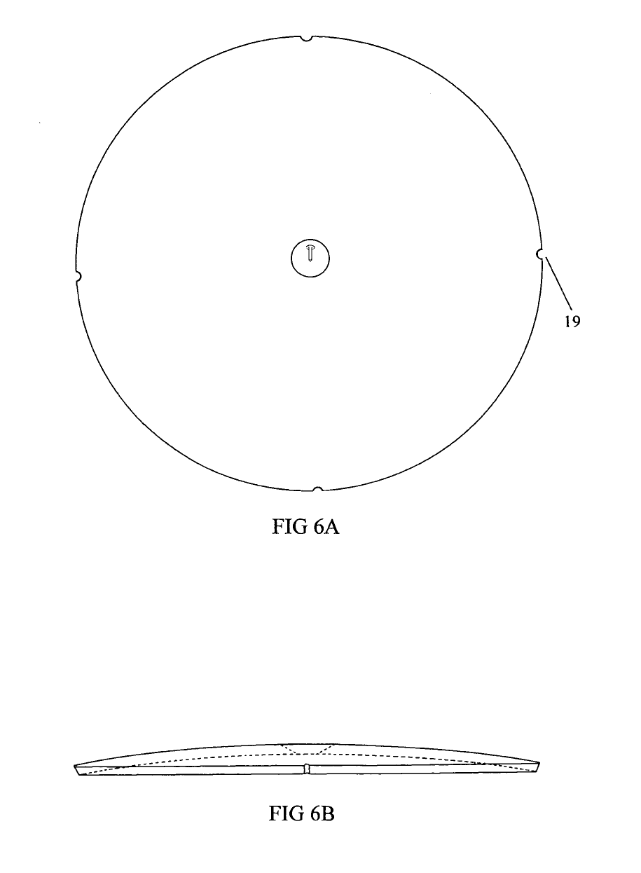

FIG. 6A depicts a front view of one embodiment of a lightweight aerodynamic wheel cover. The size of the lightweight aerodynamic wheel cover corresponds with the tire rim size it is being installed on. It is constructed of molded rigid foam dense enough to hold its spherical shape. At its center is the wheel cover attachment device depicted in FIGS. 5A and 5B. The lightweight aerodynamic wheel cover is formed with a central conical shaped hole which is large enough for the wheel cover attachment device to fit snugly into, yet small enough to stop the wheel cover attachment device from passing through. The wheel cover attachment device can be adhered to the lightweight aerodynamic wheel cover to create a lightweight aerodynamic wheel cover assembly. On its perimeter are drainage slots which allow water to drain from the wheel 19. The lightweight aerodynamic wheel cover can be coated with a thin rubberlike material which simultaneously protects it from the conditions it is exposed to and does not allow ice to bond to it.

FIG. 6B depicts a side view of one embodiment of a lightweight aerodynamic wheel cover. The lightweight aerodynamic wheel cover is spherically shaped. This shape optimally accomplishes two things: The first thing a spherical shape accomplishes, with regard to aerodynamic wheel covers, is a deflection aerodynamic drag. As the passing air travels around the wheel, it typically creates a vortex within the wheel well. This vortex creates aerodynamic drag. The presence if the lightweight aerodynamic wheel cover prevents this vortex entirely. What occurs instead is the air passing over the lightweight aerodynamic wheel cover and generating no aerodynamic drag whatsoever. The second thing a spherical shape accomplishes, with regard to this invention, is remain structurally stable against the inward (toward the wheel well) force that the tension spring 5 generates. This allows the lightweight aerodynamic wheel cover to be molded from lightweight materials.

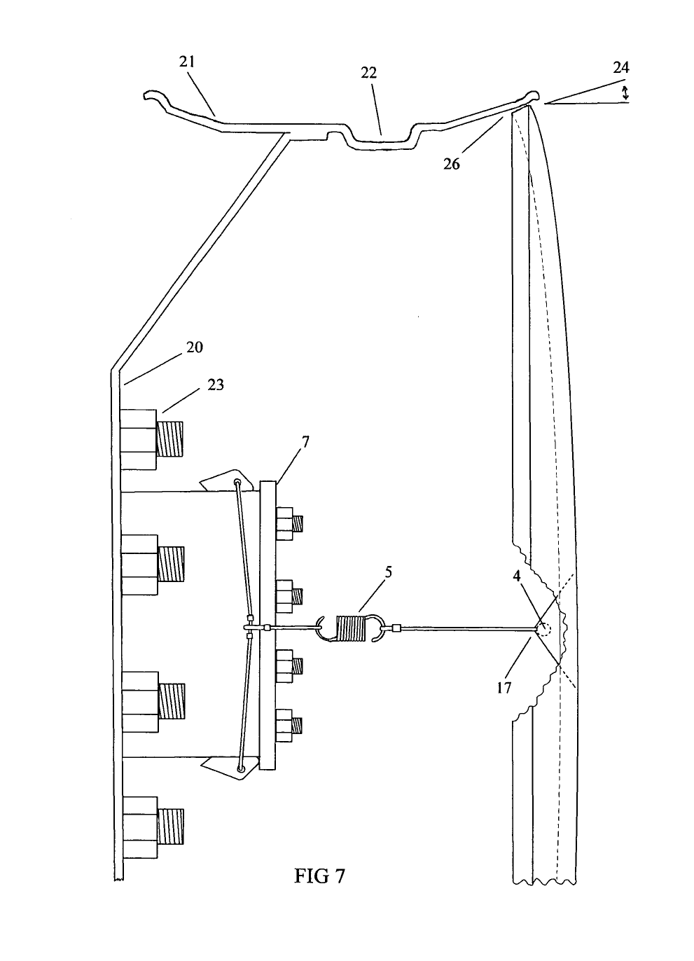

FIG. 7 depicts a side view of one embodiment of a lightweight aerodynamic wheel cover as it is attached to a typical wheel hub by one embodiment of a wheel cover attachment device and a wheel hub attachment assembly. The typical motor vehicle wheel 21 (shown in cross section view) to use and benefit from the disclosed method and device for streamlining etc; is sized to receive a conventional tubeless tire in a variety of sizes such as those having a bead diameter of 17.5 inches, 19.5 inches, 22.5 inches, or 24.5 inches. For large tractor-trailer trucks such wheels have a “bead to bead” width of about 8.25 inches although narrower wheels, such as those for motor homes may have only a width of about 6.75 inches. Such wheels may have differing locations for the “drop center” or boss portion. Also the inner surface diameter of these wheels may taper slightly at about a fifteen-degree angle 24 from the outer rim to the drop center at the inner portion of the wheels. These motor vehicle wheels have an inwardly facing, slightly tapering cylindrical cavity with a diameter that is correspondingly smaller than the corresponding bead size. For example, the 24.5 inch wheel has a tire-mounting rim with an interior diameter of about 22.5 inches. The interior surface of the wheel terminates on its inner circular end with the bolt ring or “wheel face” 20 for attaching the wheel to the motor vehicle running gear with lug nuts 23. This hollow cylinder has typically an inwardly protruding boss or “drop center” 22 positioned between the tire bead engaging portions of the rim, typically about halfway between these tire bead engaging portions. Thus, this drop center has an inner diameter less than the inner diameter of the wheel at the outer rim and at the wheel face. An exposed drop center construction is almost universally provided on current-day tubeless truck wheels. The primary purpose of this reduced diameter region of the wheel rim is to provide a location on the outwardly facing circumference of the wheel that has a smaller diameter than at the rim portions of the wheel where the tire beads will ultimately seat for the sealing bead of the tire to drop into when the tire is being mounted onto or removed from the wheel rim. 7 is a typical wheel hub referred to in FIG. 2. 5 is the tension spring referred to in FIG. 1. A cutout view of one embodiment of a lightweight aerodynamic wheel cover, referred to in FIGS. 6A and 6B, shows the attaching ball 4 in its seated position in the apex of the attachment device 17 referred to in FIGS. 5A and 5B. The lightweight aerodynamic wheel cover is angled at its outer edge to engage the inner surface of a wheel rim 26.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A wheel cover attachment system comprising:
a wheel hub attachment assembly configured to clamp to a wheel hub and attach to a wheel cover attachment device; a wheel cover attachment device,

2. The wheel cover attachment system of claim 1, wherein the wheel hub attachment assembly comprises thin steel cable, a small spring, clamping cams, a small ball, and various cable clamps and stop sleeves.

3. The wheel cover attachment system of claim 1, wherein the wheel hub attachment assembly is attached to a typical wheel hub by sliding it over the end of said wheel hub and clamping it in place with eccentrically shaped locking cams.

4. The wheel cover attachment system of claim 1, wherein the attachment assembly holds a lightweight aerodynamic wheel cover with a small ball and a wheel cover attachment device.

5. The wheel cover attachment system of claim 1, wherein the attachment assembly uses a common spring to apply pulling force to an attachment device which then holds a lightweight aerodynamic wheel cover in place.

6. A lightweight rigid foam aerodynamic wheel cover.

7. The lightweight aerodynamic wheel cover of claim 7, wherein the lightweight aerodynamic wheel cover comprises a disk formed from a lightweight rigid foam material, and protective coating.

8. The lightweight aerodynamic wheel cover of claim 7, wherein the lightweight aerodynamic wheel cover is convexly shaped in relation to the wheel it covers.

9. The lightweight aerodynamic wheel cover of claim 7, wherein the lightweight aerodynamic wheel cover has a hole at its center which the wheel cover attachment system of claim 1 attaches to.
